(19) United States
(12) Patent Application Publication
(10) Pub. No.: US 2003/0102348 A1
(43) Pub. Date: Jun. 5, 2003

(54) Hand tool for severing and removing carrier pins of helically wound thread inserts formed from metal wire

(76) Inventors: Conny Andersson, (US); Rustan Olsson, Gundlebo (SE)

Correspondence Address: Dickstein Shapiro Morin & Oshinsky, 2101 L Street NW, Washington, DC, 20037-1526, US

(21) Appl. No.: 10/312,865

(22) PCT Filed: Aug. 13, 2001
(86) PCT No.: PCT/SE01/01745

(30) Foreign Application Priority Data
Aug. 11, 2000 (SE) 0002893-6

(51) Int. Cl. B26F 3/02

(52) U.S. Cl. 225/72

(57) ABSTRACT

A hand tool for severing and removing an end portion (36) of a helically wound thread insert (37) formed from metal wire and mounted in a bore (38), including a hand support (11), an operating mechanism (12, 13, 14) and severing means (7). The severing means includes a spindle member (16) and a loop shaped member (17′) axially movable relative to one another in response to actuation of said operating mechanism so as to clamp an end portion (36) of said thread insert between an end portion (16g) of said spindle member and said loop shaped member (17′).

The present invention concerns a hand tool for severing and removing an end portion of a helically wound thread insert formed from metal wire and mounted in a bore, including a hand support, an operating mechanism and severing means.

Tread inserts of this kind are known since long and have been utilized, inter alia, for repair purposes, viz., to replace damaged or corroded threads in holes in larger work pieces of, for instance, cast iron, such as engine blocks. After adapted boring and threading of the hole having the damaged thread, a helically wound insert formed from metal wire is inserted, said insert, after having been inserted, exhibiting on its inner side a contour substantially corresponding to the original hole thread and, thus, capable of offering a good hold for a bolt or screw screwed into it. When normal right-threaded threads are concerned, and, consequently, a right-threaded winding of the insert, the latter may comfortably be threaded into the widened hole by means of a portion thereof bent at an angle from the termination of the innermost winding turn and preferably directed radially inwardly, said portion forming a carrier pin. During threading into the hole by means of this pin, the outer diameter of the insert is somewhat reduced by friction so that the screwing in is facilitated, but after completed screwing home, the insert strives to regain its original width and, therefore, it braces itself against the wall of the hole.

Thread inserts of this kind have also been used in original industrial production, particularly in materials that are sensitive and difficult to provide with threads. One such application is objects manufactured from titanium and titanium alloys exhibiting a large sensitivity for metallurgic structural change at machining. In order to get around the risks involved herein, the above-mentioned thread inserts are preferably used in, for instance, the manufacture of intermediate houses for gas turbines, particularly when a larger number of threaded mounting holes is to be provided, nearly one hundred and forty holes in such an intermediate house.

To some extent, manufacturers of thread inserts supply suitable special tools for severing the carrier pin after insertion of the thread insert in a hole so that it no longer prevents screwing in of the appropriate threaded bolt. Severing occurs in the direction of the thread, or, away from the thread start of the insert. For this purpose, the thread inserts are delivered with a small kerf in the last thread turn of the thread insert close to the inwardly angled carrier pin.

However, recent increasingly standardized quality demands, such as ISO 9001 and others, call for a more “organized” severing of carrier pins that otherwise tend to spatter around in the factory premises unless they do not simply fall down into the hole in an uncontrollable manner. Particularly within the aircraft engine industry this constitutes a troublesome circumstance when it comes to complying with the quality demands of engine buyers.

Accordingly, there has existed a demand for some time to control in a better manner the severing of the carrier pins in question and in a likewise controlled manner to retrieve them for reliable collecting. It is possible even to check that all pins have been restored by weighing a specific number so that none remains in the engine in a place where it could cause damage.

Consequently, the present invention has as its object to solve the problems stated by proposing a hand tool of the kind initially mentioned. This has been accomplished in that the severing means includes a spindle member and a loop shaped member axially movable relative to one another in response to actuation of said operating mechanism so as to clamp between an end portion of said spindle member and said loop shaped member an end portion of said thread insert.

Although it is presently preferred that the operating mechanism is manually powered, it is evident that it may be powered by external force, such as pressurized air.

By means of the present invention it can now be guaranteed that the carrier pins broken loose are taken care of in an advantageous and secure manner and no longer can constitute an injury risk, neither for staff or environment in the production premises nor in the ready assembled product.

The tool according to the present invention will be more closely described hereinbelow, reference being made to the accompanying drawing, wherein

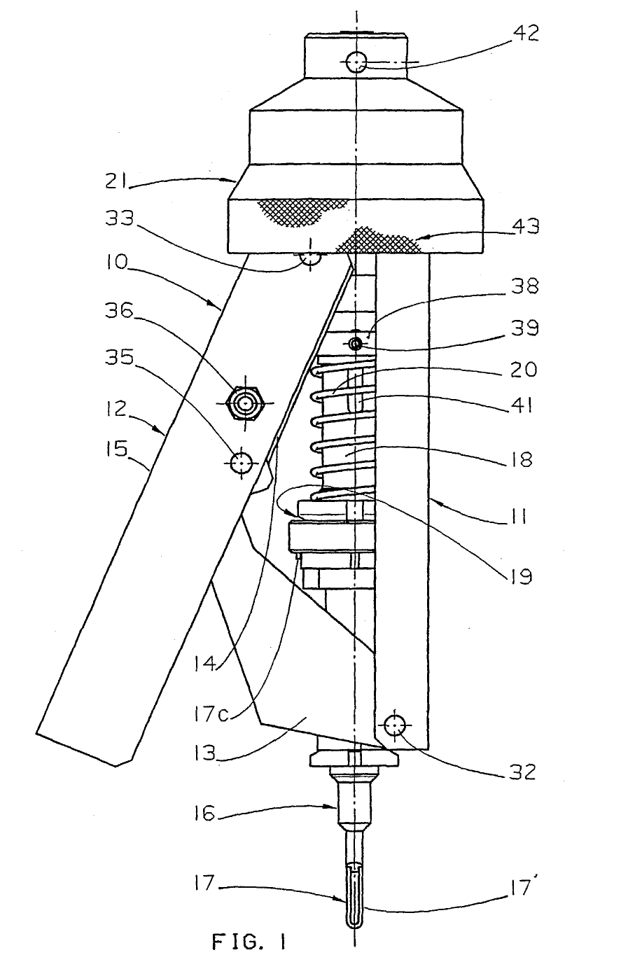

FIG. 1 is a side view of the tool,

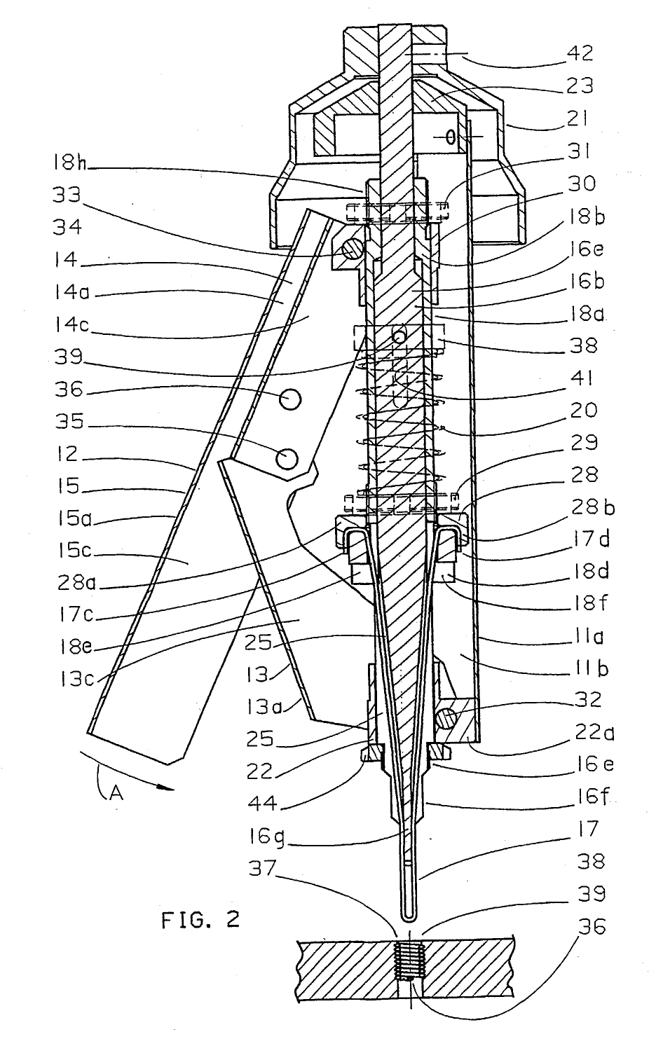

FIG. 2 is a longitudinal section through the tool according to FIG. 1,

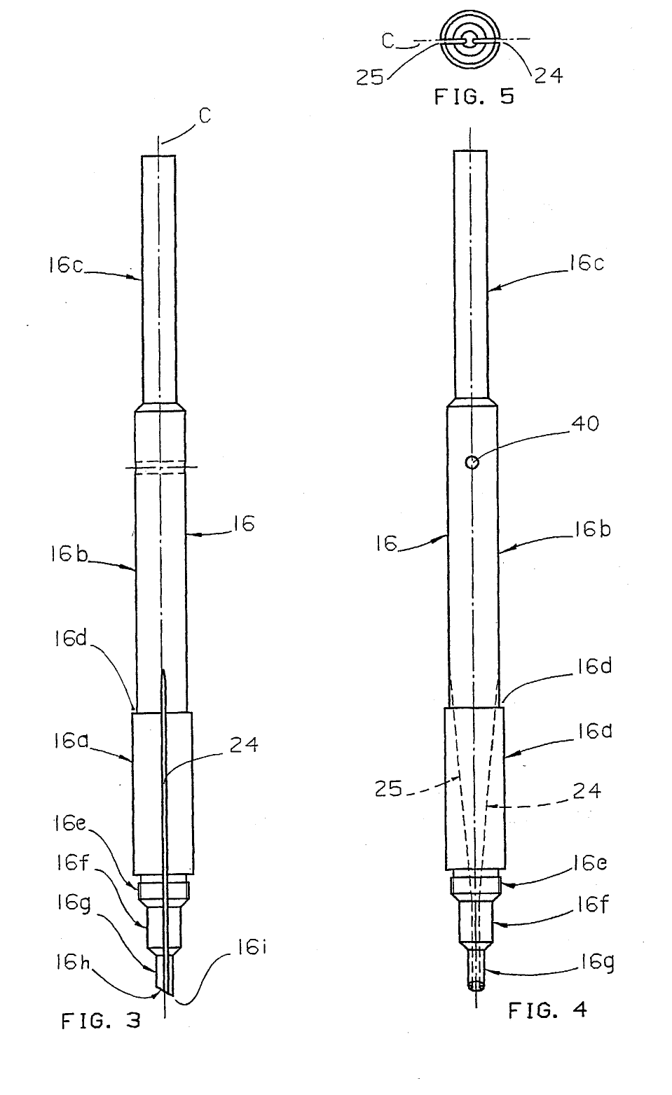

FIG. 3 is a first side view of a spindle of the tool,

FIG. 4 is a second side view of the spindle seen from the left in FIG. 3,

FIG. 5 is an end view of the spindle;

FIG. 6 is a plan view of the hairpin shaped wire;

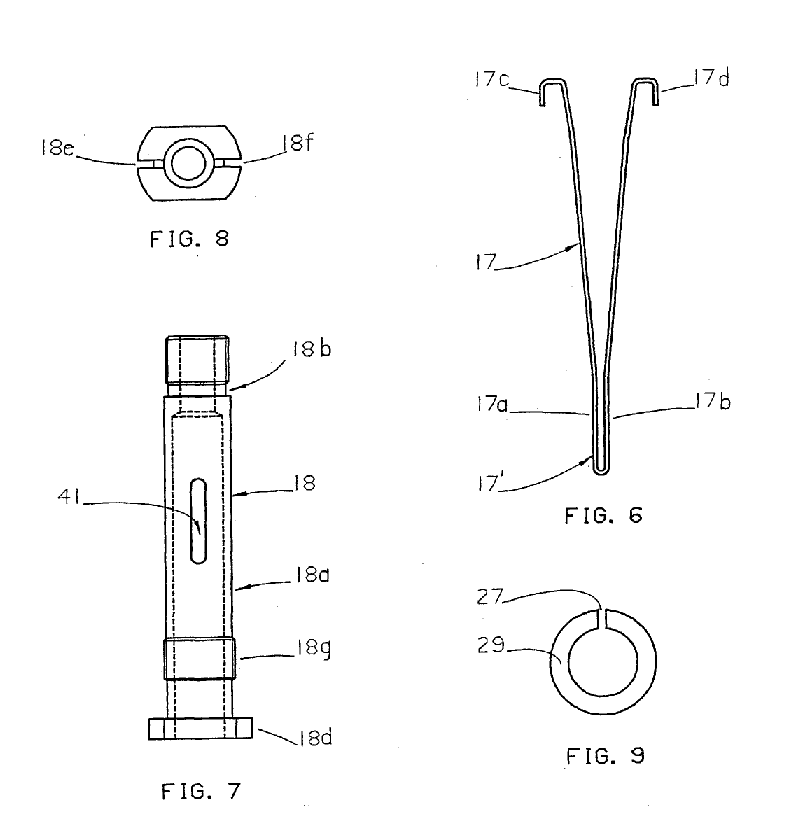

FIG. 7 is a side view of a sleeve surrounding the spindle,

FIG. 8 is an end view of the sleeve of FIG. 7;

FIG. 9 is an end view of a slotted ring;

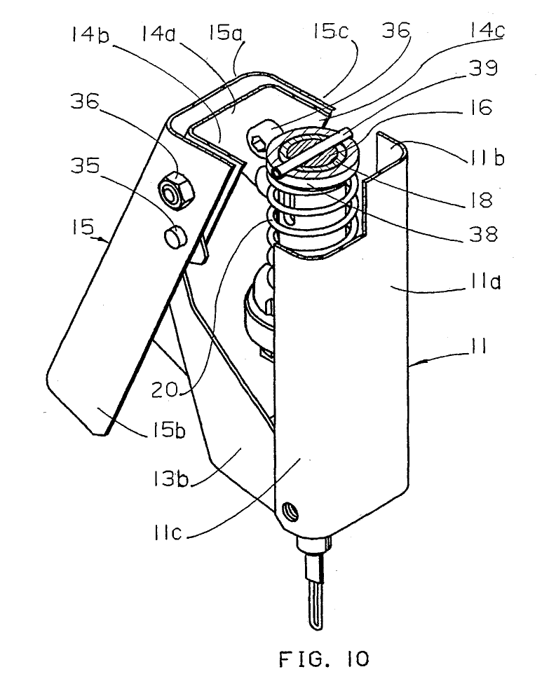

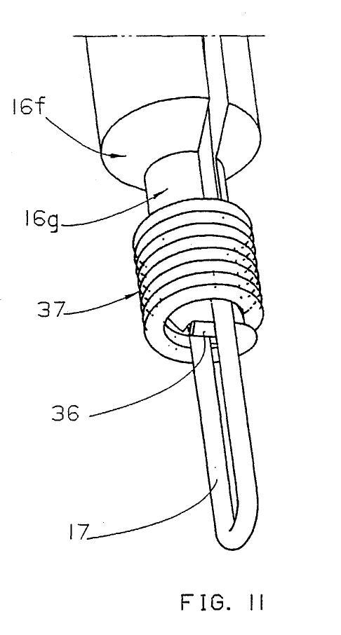

FIG. 10 is a perspective sectional view taken along line II-II of FIG. 2, and

FIG. 11 is a perspective view at a large magnification showing engagement of the severing means with the carrier pin of the thread insert.

FIG. 1, showing an overall view of the tool 10, at lest partly reveals most of its components, viz., a shell-like hand support 11, a toggle joint mechanism 12 comprising two linked arms 13 and 14 as well as a manually operable handle lever 15, an axially movable spindle 16, a hairpin shaped wire 17, a sleeve 18 surrounding the spindle 16 and carrying attachment means 19 for the wire 17, a return spring 20 for the spindle 16, and a knob 21 for rotating the spindle 16 and the wire 17.

As appears more clearly from FIGS. 2 and 10, the shell-like hand support 11 has a substantially U-shaped cross section, including a web portion 11a and two flange portions 11b, 11c. The web portion 11a carries a forward slide bearing 22 and a rear slide bearing 23.

The spindle, shown separately in FIGS. 3, 4 and 5, includes a forward cylindrical portion 16a, an intermediate cylindrical portion 16b having a reduced diameter, and a rear cylindrical portion 16c having a further reduced diameter. A shoulder 16d is formed between the forward cylindrical portion 16a and the intermediate cylindrical portion 16b. As seen in FIG. 2, the forward spindle portion 16a is slidingly received in the forward sliding bearing 22 and the rear spindle portion 16c is slidingly received in the rear sliding bearing 23 so as to enable a reciprocating movement of the spindle.

The forward cylindrical portion 16a of the spindle transforms into a stepwise reduced diameter end portion including a threaded portion 16e, an abutment portion 16f and a tip portion 16g. As seen particularly in FIG. 3, the tip portion has a beveled end surface 16h having an edge 16i. The inclination of the end surface is preferably 60° relative to the longitudinal axis of the spindle.

Two opposed grooves 24, 25, starting in the intermediate cylindrical portion 16b close to its transition into the forward cylindrical portion 16a, extending throughout the forward cylindrical portion 16a and the abutment portion 16f, and terminating at the end of the tip portion 16g, are cut into the spindle 16. As appears from FIG. 2, the bottoms 24′, 25′ of these grooves approach one another towards the tip portion 16g, along which they extend substantially parallel. As appears from FIG. 3 and the end view of FIG. 5, the opposed grooves are not diametrically opposed but are somewhat eccentrically displaced towards the edge 16i relative to a central plane C through the spindle. The width of the grooves is adapted to enable location therein of the hairpin shaped wire 17.

The hairpin shaped wire 17, shown separately in FIG. 6, is a generally V- or, rather, Y-bent wire having a forward end 17′ formed like a U-shaped loop with substantially parallel legs 17a, 17b flaring towards their free ends. At their free ends, the legs are formed with radially and forwardly bent hook-like end portions 17c, 17d, respectively. The space between the legs 17a, 17b at the U-shaped end is adapted to enable introduction therein of a carrier pin to be severed.

In order to severe a carrier pin introduced between the legs 17a, 17b close to the U-shaped loop end 17′, the edge 16h of the spindle and the hairpin shaped wire located in and guided by the grooves 24, 25 are caused to move longitudinally relative to one another such that the beveled end surface 16h and its edge 16i approach the U-shaped end or loop 17′ and pinch the carrier pin between the loop and edge 16i. Due to the beveled end surface 16h, the loop 17′ may travel past the edge, resulting in bending of the carrier pin about the edge. Such bending will result in severing of the end portion of the thread insert from the remainder thereof, particularly if a kerf is provided to facilitate severing. The severed end portion will be maintained clamped between the beveled end surface 16h and the loop 17′ to be removed from within the thread insert and the hole in which it is mounted.

To provide relative movement between the spindle 16 and the loop 17′, a main portion 18a of the sleeve 18 is slidingly received on the intermediate cylindrical portion 16b of the spindle and connected to the wire 17 by means of the attachment means 19 initially mentioned and to be described below. The inner diameter of the main portion of the sleeve is adapted to the outer diameter of the intermediate cylindrical portion 16b, and, consequently, the shoulder 16d forms an abutment for the forward end of the sleeve. A rear portion 18b of the sleeve slidingly receives the rear cylindrical portion 16c of the spindle.

The forward end of the sleeve has a radial flange 18d provided with opposed radial slots 18e, 18f aligned with the slots 24, 25, respectively, of the spindle 16. A portion of the sleeve adjacent the flange is threaded at 18g.

The attachment means 19 includes a ring 26, separately shown in FIG. 9, having at one position at its circumference a slot 27 and being slipped onto the sleeve 18 from the rear end thereof to abut the radial flange 18a. The ring being turned to align the slot 27 with one of the grooves 23, 24, and, thus, with one of the slots 18e, 18f of the flange 18d, one leg 17a, 17b of the hairpin shaped wire 17 may be introduced with its hook-like end portion 17c, 17d through both aligned slots. The ring then being turned through substantially 180° to align its slot 27 with the other of the grooves, and the other of the slots 18e, 18f, the other of the legs may be introduced with its hook-like end portion through both these slots. Finally, the ring is rotated to locate its slot 27 between the two hook-like end portions 17c, 17d, such as 90°. In this position, shown in FIG. 2, the hook-like end portions grip around unslotted portions of the circumference of the ring 26. The attachment means further includes a cup-shaped washer 28, having a radially extending main portion 28a and an axially extending flange 28b. Finally, the attachment means includes a nut 29 threaded onto the threads 18g of the sleeve. Upon tightening of the nut 29, the radially extending main portion 28a of the washer 28 abuts the radially extending portions of the hook-like end portions of the hairpin shaped wire 17, whereas its axially extending flange portion 28b grasps over the axially extending ends of the hook-like end portions 17c, 17d, thereby securely clamping the hairpin shaped wire to the sleeve 18.

A pressure sleeve 30 is mounted on the rear end of the sleeve 18 and a nut 31 is screwed onto its threads 18h.

The arm 13 of the toggle joint mechanism 12, also having a substantially U-shaped cross section including a web portion 13a and two flange portions 13b, 13c, is linked in its forward end to a first transverse pivot pin 32 extending through an attachment portion 22a of the forward sliding bearing 22 and its flange portions 13b, 13c. The arm 14, likewise having a substantially U-shaped cross section including a web portion 14a and two flange portions 14b, 14c, is linked in its rear end to a second transverse pivot pin 33 extending through an ear 34 integral with the pressure sleeve 30 and through its flange portions 14b, 14c. The arms 13 and 14 are pivotedly linked together by means of a pair of aligned transverse pivot pins 35 extending through the respective flanges 13b, 14b and 13c, 14c of the arms 13 and 14 to form a complete toggle joint mechanism. In order to facilitate manual operation of the toggle joint mechanism, the handle lever 15, likewise having a substantially U-shaped cross section including a web portion 15a and two flange portions 15b, 15c, is operably connected to the arm 14. This is achieved by connecting the flange portions of the arm 14 and the lever 15 by means of at least one of the pivot pin 33 and the pair of pivot pins 35 as well as a pair of separate screw/nut connections 36.

Manual operation of the handle lever 15 in a direction indicated by an arrow A in FIG. 2, will cause an extension of the toggle joint mechanism 12, i.e., a relative movement apart of the pivot pins 32 and 33 and, consequently, of the sliding bearing 22 and the pressure sleeve 30. This latter abutting the nut 31 threaded onto the threads 18h will cause a corresponding movement of the sleeve 18 and of the hairpin shaped wire 17 relative to the spindle 16, the latter being restricted in its movement by a nut 44 threaded onto the threads 16e and abutting the forward sliding bearing 22. Consequently, the edge 16h of the spindle and the U-shaped end portion 17′ of the hairpin shaped wire will relatively approach one another and eventually pinch and severe a carrier pin 36 (FIG. 11) of a helical thread insert 37 inserted in a hole 38 (FIG. 2) in a structure 39. The severed carrier pin 36 will be kept pinched between the wire end 17′ and the spindle end and may be retrieved from inside the hole to be disposed of in any suitable manner.

In order to achieve a relative return stroke of the spindle and the hairpin shaped wire to release the severed carrier pin and to return the relatively movable parts of the tool to their initial position shown in FIGS. 1 and 2, the return spring 20 in the shape of a helical pressure spring, surrounds the sleeve 18 abutting with its one end the nut 29 and abutting with its other end a ring 38 also surrounding the sleeve 18. The ring 38 is connected to the spindle 17 by means of a pin 39 diametrically extending through the ring and a hole 40 provided through the spindle. In order to be free to move relative to the sleeve 18, the latter is provided with opposed longitudinally extending slots 41.

In its rear end extending beyond the rear sliding bearing 23, the spindle carries the knob 21 being substantially cap shaped. The knob is attached to the spindle by means of a pin 42 so as to enable rotation thereof and of the hairpin shaped wire engaged in the opposed grooves 24, 25. Hereby, the U- or loop-shaped end portion 17′, as well as the edge 16h, may be rotated according to the orientation of the carrier pin 36 of the thread insert 37. At least a portion of the exterior of the knob may be knurled as shown at 43 in FIG. 1 to facilitate rotation thereof with the thumb of a hand gripping the tool to operate the handle lever 15.

When introducing the end portion 17′ of the wire 17 and the tip end 16g of the spindle into a thread insert 37, the abutment portion 16f of the spindle is intended to abut the area around the hole 38 in which the thread insert is inserted in order to prevent extreme introduction thereof.

1. A hand tool for severing and removing an end portion (36) of a helically wound thread insert (37) formed from metal wire and mounted in a bore (38), including a hand support (11), an operating mechanism (12, 13, 14) and severing means (7), characterized in that the severing means includes a spindle member (16) and a loop shaped member (17′) axially movable relative to one another in response to actuation of said operating mechanism so as to clamp an end portion (36) of said thread insert between an end portion (16g) of said spindle member and said loop shaped member (17′).

2. The hand tool according to claim 1, characterized in that an end surface (16h) of said spindle member is beveled, preferably about 60°, relative to a central plane (C) through said spindle so as to form an edge (16i).

3. The hand tool according to claim 2, characterized in that said spindle member (16) is provided with peripheral, opposed axially directed grooves (24, 25) to guide relative movement between said spindle member (16) and said loop shaped member (17′).

4. The hand tool according to claim 3, characterized in that said grooves (24, 25) are located in a plane eccentrically displaced in relation to said central plane (C).

5. The hand tool according to any one of the preceding claims, characterized in that said spindle member (16) and said loop shaped member (17′) are rotatable relative to said hand support.
